(19) United States
(12) Patent Application Publication
(10) Pub. No.: US 2002/0127512 A1
(43) Pub. Date: Sep. 12, 2002

(54) Ultrasonic unit with rear swivel

(76) Inventors: Shu Chen, Buffalo Grove, IL (US); Richard H. Paschke, Timonium, MD (US); Anisur M. Rahman, Gurnee, IL (US); David W. Tipton, Rolling Meadows, IL (US)

Correspondence Address: WELSH & KATZ, LTD, 120 S RIVERSIDE PLAZA, 22ND FLOOR, CHICAGO, IL, 60606, US

(21) Appl. No.: 10/080,311

(22) Filed: Feb. 21, 2002

Related U.S. Application Data
(60) Provisional application No. 60/270,687, filed on Feb. 22, 2001.

(51) Int. Cl. A61C 3/03; A61C 1/08

(52) U.S. Cl. 433/119; 433/126

(57) ABSTRACT

An adapter for use with a piezoelectric and/or magnetostrictive ultrasonic unit can be coupled between the handpiece and the cable. The adapter includes a symmetrically oriented flow path with offset ends to mate with the handpiece and the cable respectively. The adapter also includes a rotary electrical connection facilitating the transfer of energy from the cable to the handpiece while the handpiece is being rotated. The rotary connection of the adapter can be integrated into either of the handpiece or the cable termination.

This application is a utility application claiming the benefit of the earlier filing date of provisional application Serial No. 60/270,687 filed Feb. 22, 2001.

### FIELD OF THE INVENTION

The invention pertains to ultrasonic dental instruments. More particularly, the invention pertains to such instruments which are freely rotatable with limited amounts of torque to improve operator performance and to reduce fatigue.

### BACKGROUND OF THE INVENTION

Ultrasonic instruments are commonly used by dental practitioners in scaling, periodontal treatments, root canal therapy or other types of dental treatments. The two commonly used classes of instruments used by dental personal are driven respectively by magnetostrictive or piezoelectric transducers. The structures and characteristics of the two types of instruments are different.

Magnetostrictive instruments usually include a hollow handpiece to which is attached a multi-conductor cable which also includes a fluid delivery conduit. Ultrasonic inserts which carry treatment tip and a magnetostrictive transducer slide into and engage the hollow handpiece with a friction fit.

One particular form of insert has been disclosed and claimed in Rahman et al. U.S. utility patent application Ser. No. 09/917,101 entitled Ultrasonic Swivel Insert assigned to the Assignee hereof. Rahman et al. was directed to a magnetostricive-type insert which when inserted into the handpiece, could be rotated relative to the handpiece. In Rahman et al. as in most known magnetostricive units, the handpiece is fixedly attached to the fluid/electrical cable. Thus, the handpiece in these units and the cable form an integral unit wherein they can not be separated from one another.

Some piezoelectric units have a fluid supply/electrical cable which can be unplugged from the handpiece. In these units, the treatment tip is not part of a slidably engagable insert. Instead, the treatment tip is threaded and rotatably engages a transducer carried within the handpiece. Hence, the transducer, handpiece and treatment tip represent an integral unit. The tip can not be rotated with respect to the handpiece.

Since it has been recognized that there is an advantage in being able to relatively easily rotate the tip relative to patient anatomy during treatment, it would be desirable to be able to rotate the tip of a piezoelectric handpiece relative to at least the cable. Additionally, it would be desirable to provide such functionality for the numerous existing and installed piezoelectric units in a cost effective and efficient fashion.

### BRIEF DESCRIPTION OF THE DRAWINGS

FIG. 1A is an overall view of a system in accordance with the invention;

FIG. 1B is an exploded view, partly in section, illustrating various aspects of an ultrasonic instrument as in FIG. 1A;

FIG. 2A-2E taken together illustrate a collet-type rotary connection;

FIGS. 3A,B taken together illustrate a split ring-type rotary connection;

FIG. 4 illustrates a twist lock-type rotary connection;

FIGS. 5A,B illustrate a sleeve-type rotary connection;

FIG. 6 illustrates a cylindrical-type rotary electrical connection;

FIGS. 7A,B illustrate an annular-type rotary electrical connection;

FIG. 8 illustrates a cable -type rotary electrical connection;

FIG. 9 illustrates a coiled spring-like rotary electrical connection; and

FIG. 10 is a sectional view of an adapter with a locking ring and a cylindrical rotary conductor as in FIG. 6.

### DETAILED DESCRIPTION OF THE PREFERRED EMBODIMENTS

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

An ultrasonic treatment unit can incorporate a handpiece and a base. The base is coupled by cable to a source of pressurized treatment fluid and a source of electrical energy. The handpiece is rotatably coupled to the base with a rotary fluid seal and rotary electrical connector such that fluid and electrical energy can be coupled from the base to the handpiece. A seal between the handpiece and base blocks fluid from leaking. Rotatable electrical connections couple the electrical conductors in the base to the handpiece. The rotatable connection can provide smooth and unrestricted rotatability of the handpiece with respect to the connecting cable thereby eliminating the drag of the cable and improving operator comfort.

In one embodiment, a rotary adapter is provided between the base and the handpiece. The base and handpiece can be directly coupled together. Alternately, they can be coupled together with the adapter therebetween. When so coupled, the handpiece and treatment applying tip can be rotated by a practitioner relative to the base to improve the ease and efficiency of a treatment, for example a dental scaling operation.

In another embodiment, a rotatable element can be integrated into one of the base or the handpiece. In this instance, coupling the base and the handpiece together results in a unit, without a separate adapter wherein the handpiece can be rotated relative to the base during treatment.

In either of the above embodiments, a rotatable, sealed fluid coupling is located between the base and the handpiece. Additionally, a multi-conductor electrical connection is established through the rotatable structure to energize the handpiece.

A rotary function can be imparted to a piezoelectric ultrasonic unit by means of an adapter which has an input section and an output section. Multiple electrical conductors and a fluid flow conduit extend between the input and the output sections. Mating terminals are provided at each of the input and output sections configured with a form factor which mates with a respective handpiece and a cable. The offset flow conduits in the handpiece and the cable are matched and combined with a centrally located rotary fluid flow joint.

The rotary flow path is sealed with an elastomeric seal which provides dynamic sealing during rotation. The seal is trapped between the sections.

The sections can be locked together using a locking ring or a collet-like structure. Alternately, a twist lock-type connection can be used. Other structures to rotatably couple the sections can be used without departing from the spirit and scope of the present invention.

The sections for the adapter can be molded of a sterilizable resin. The resin may be impregnated with lubricants to provide a smooth bearing function.

Where the collet-type locking mechanism is used, the two sections can be assembled with an axial force which will collapse the collet body inside of a cylindrical inner periphery of the other section. When a locking surface of the collet slides into a matching groove it will expand radially into the groove. This will lock the two sections together axially without impeding rotation therebetween.

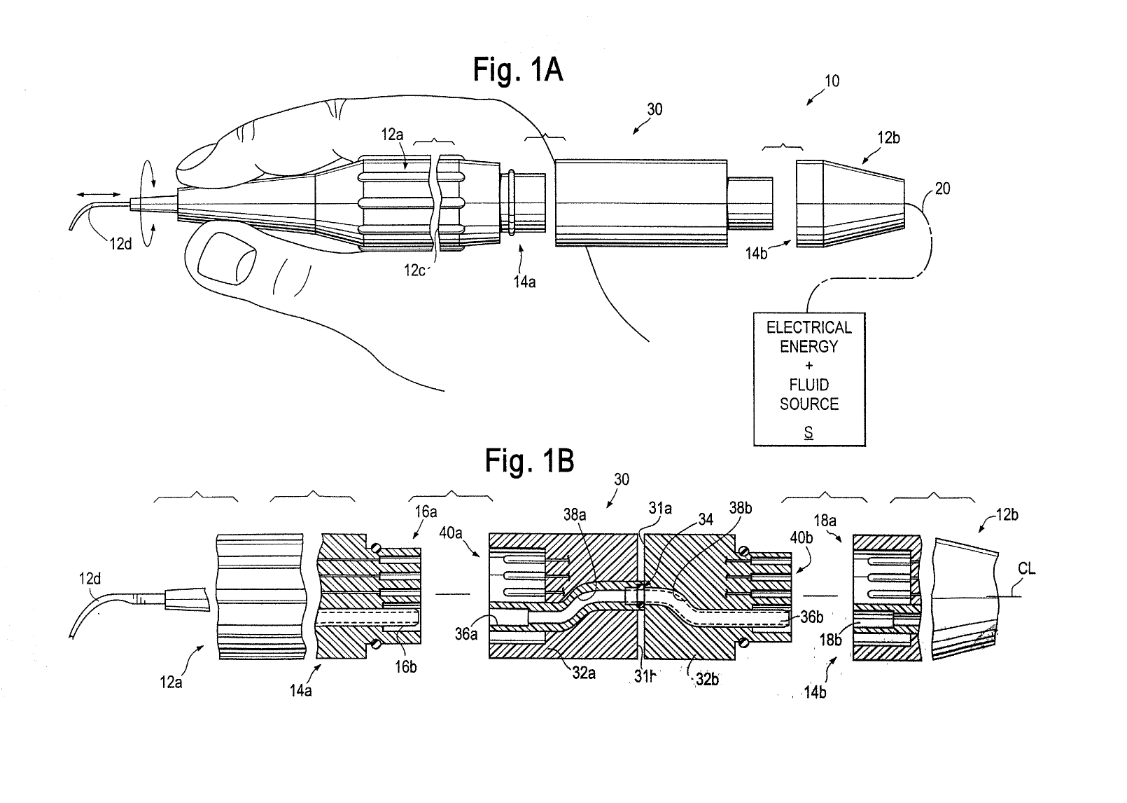

FIGS. 1A,B illustrate a system 10 in accordance with the present invention. The system 10 can be used with a piezoelectric ultrasonic treatment instrument of a known type having a handpiece 12a and a cable connection or base 12b. In normal usage, the handpiece 12a also carries a piezoelectric transducer indicated generally at 12c which is mechanically coupled to and drives a treatment applying tip 12d. The handpiece is coupled, via a connector 14a to a mating connector 14b which is carried on the base or cable connection 12b.

In normal operation, as would be understood by those of skill in the art, the handpiece 12a is coupled to the cable connection 12b for purposes of driving tip 12d with ultrasonic vibrations and providing a simultaneous fluid spray to facilitate the selected treatment. Possible treatments include ultrasonic scaling, as well as periodontal or endodontic therapies.

Also as known to those of skill in the art, the connectors 14a, 14b slidably engage one another with a friction fit whereby a multi-conductor electrical socket indicated generally at 16a, offset from a centerline CL of the handpiece 12a. The connector 14a also carries a fluid input stub 16b which functions as a fluid flow receiving port for the handpiece 12a. The received, pressurized fluid, is in turn coupled to the vibrating tip 12d to provide a cooling or therapeutic spray to the patient's anatomy. The fluid input port stub 16b is also offset from the centerline CL of the instrument.

The connector 14b carries a multi-conductor plug indicated generally at 18a which has a form and a fit factor compatible with the multi-conductor electrical socket 16a. Additionally, the connector 14b carries a fluid output port 18b, which could be configured as a female socket member, offset from the centerline CL. The fluid outflow port 18b is configured so as to slidably engage the fluid inflow port 16b of the handpiece 12a.

When the handpiece 12a is coupled to the cable connector 12b, the respective mating elements such as socket 16a, plug 18a, and plug 16b, socket 18b slidably mate together forming an electrical/fluid connection. Electrical energy from a remote source S provided by cable 20 can in turn be coupled through handpiece 12a to tip 12d. Similarly, fluid from a remote source coupled by a cable 20 to handpiece 12a can be provided under pressure to tip 12d to form a treatment/therapeutic spray at the treatment region of the patient.

Also as would be understood by those of skill in the art, the offset nature of the socket 16a and port 16b, when coupled to connector 14b precludes rotation therebetween.

As illustrated in more detail in FIG. 1B, a rotary adapter 30 can be coupled between handset 12a and cable connector 12b. The rotary connector 30 includes a first housing section 32a and a second housing section 32b. The housing sections 32a,b are rotatably coupled together in any one of a variety of ways including collet-type, locking rings, or a twist lock connection all without limitation and all without departing from the spirit and scope of the present invention.

A rotary fluid seal indicated generally at 34, is formed adjacent to surfaces 3 1a,b. It could be implemented as an annular ring symmetrically located on the centerline CL of the instrument. As a result of the rotary seal 34, the sections 32a,b can be rotated relative to one another while pressurized fluid is being coupled from cable 20 to tip 12d for treatment purposes. The seal 34 precludes fluid leakage.

To implement the rotary seal 34, first and second offset flow ports 36a,b are redirected by respective internal conduits 38a,b along the centerline CL of the instrument and substantially symmetrically located relative to the seal 34. Redirecting fluid flow from the cable 20 to the centerline CL of the instrument and substantially symmetrically located relative to the seal 34 as illustrated in adapter 30 makes it possible to cost effectively and conveniently provide the desired rotary seal.

Seal 34 can be implemented in part with an O-ring molded of an elastomeric material. Those of skill will understand that other types of elastomeric seals which could take the form of flat gaskets could be used without departing from the spirit and scope of the present invention.

Electrical energy provided from the remote source S by a cable 20 can be coupled from plug 18a through adapter 30 to socket 16a using a variety of rotation compatible electrical paths. For example and without limitation, conducting members within the adapter 30 could include spring biased cylindrically formed conductive elements insulated from one another by an insulating barrier of the type that would be understood by those of skill in the art.

Alternately, a rotary electrical connector having first and second parts rotatable relative to one another can be incorporated into the member 30. Finally, the rotatable electrical paths within member 30 could be implemented using discreet wires or flexible cables connected between electrical plug 40a and electrical socket 40b.

When the piezoelectric ultrasonic handpiece 12a and cable element 12b are coupled together via adapter 30, the handpiece 12a and tip 12b are readily rotatable relative to cable connector 12b and cable 20. Hence, the practitioner treating the patient's anatomy, for example the patient's teeth or gums, is readily able to rotate the tip 12d as needed during the course of treatment without having to overcome torque set up by cable 20 as a result of twisting same. Additionally, the adapter 30 is especially advantageous in that it is form and fit compatible with existing instruments and can simply be added between the handpiece 12a and connector element 12b as the practitioner is preparing the instrument for use.

The adapter 30 is sterilizable using gas, heat, chemicals or any other form of sterilizing process as would be known to those of skill in the art.

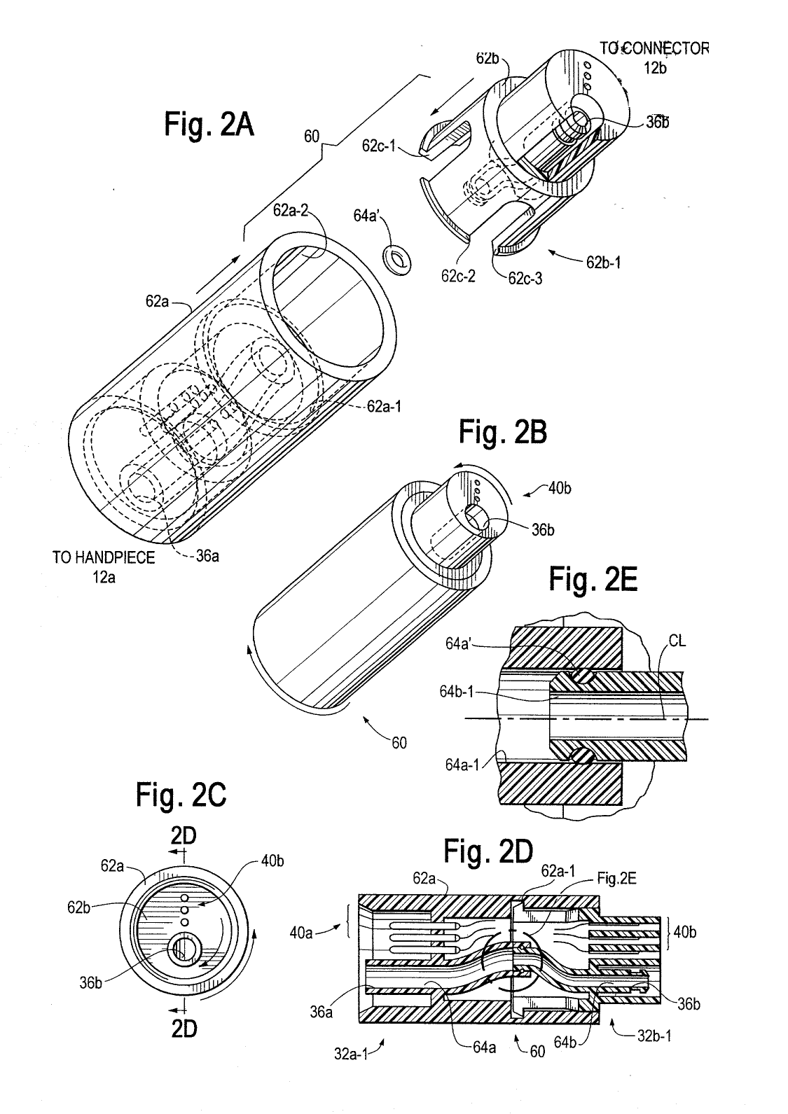

FIGS. 2A-2E illustrate details of a collet-type rotatable connector 60 for the housing sections, such as sections 32a-1,b-1. A housing 62a, which would engage the handpiece 12a, carries an internal annular slot 62a-1. A second housing 62b carries a collet-type locking member 62b-1. The member 62b-1 carries at least one laterally deflectable locking member, such as 62c-1,2,3,4.

As the housings 62a,b are axially forced together along a common center line, the one or more locking members 62c-1,2,3,4 are forced laterally inward toward the centerline when they slidably engage an internal cylindrical surface 62a-2. As the two housings continue to move axially toward one another, the one or more locking members 62c-1,2,3,4 will slide into the annular slot 62a-1.

As the locking members move into the slot 62a-1 they expand laterally, or radially, away from the centerline into the slot. This lateral expansion rotatably locks the two housing sections 62a,b together. At the same time, the fluid seal 64a′ is trapped between the two housings thereby providing a rotary fluid seal for the two fluid flow paths 64a,b which become symmetrically located on the centerline CL. Thus, the two sections 32a′,b′ can rotate relative to one another while at the same time coupling electrical energy and fluid therethrough.

FIG. 2D illustrates that fluid flow sections 64a-1 and 64b-1 which mate are symmetrical with respect to the centerline CL. The annular seal 64a is compressed therebetween thereby implementing the rotary seal. The conduits 64a,b are non-linear and curve from a position displaced laterally from the center line CL toward the centerline and symmetrical with respect thereto.

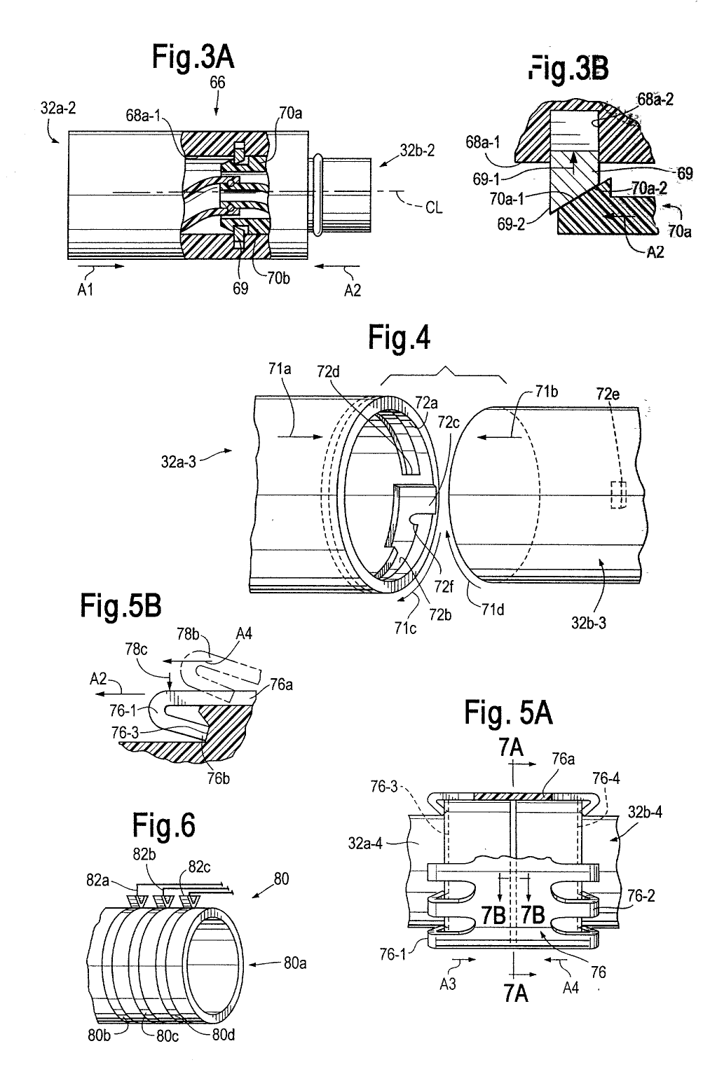

FIGS. 3A,B illustrate a split ring-type rotary connection 66. Connection 66 is formed between sections 32a-2,b-2. Section 32a-2 has an internal cylindrical periphery 68a-1 which defines an internal annular slot 68a-2. A split ring 69 is installed in slot 68a2.

Section 32b-2 carries a plurality of axially extending fingers, 70a,b, . . . n. The fingers are substantially identical and a discussion of finger 70a will also describe the others.

Finger 70a has a first biased surface 70a-1 at an acute angle to the centerline CL, and a second, intersecting, radially oriented surface 70a-2. As the sections 32a-2,b-2 are forced together axially the biased surfaces, such as the surface 70a-1 force the split ring 69 radially outwardly 69-1.

When the biased surfaces, such as 70a-1 slide past the ring 69, the ring contracts, returning to its original shape and size by moving in a radial direction opposite direction 69-1. Surface 69-2 of ring 69 now abuts a plurality of radially oriented surfaces, such as surface 70a-2.

The interference between surface 69-2 and the plurality of surfaces, such as 70a-2, precludes axial movement of sections 32a-2,b-2 away from one another. However, rotary motion is not blocked. Hence when a split ring-type connection is implemented in an adapter, such as the adapter 30, the desired relative rotary motion between handpiece 12a and cable connector 12b will be present.

FIG. 4 illustrates a twist lock-type connection between sections 32a-3,b-3. Section 32a-3 exhibits an internal peripheral surface 72a which carries an internal annular slot 72b. The slot 72b starts at a port 72c and terminates at a surface 72d.

The section 32b-3 carries an external protrusion 72e. As the sections 32a-3,b-3 are forced toward one another directions 71a,b the protrusion 72e enters port 72c. When the sections 32a-3,b-3 are rotated relative to one another, 71c,d the protrusion 72e slides past blocking surface 72f and into rotary slot 72b. Once in slot 72b, protrusion 72e and section 32b-3 can be rotated, relative to section 32a-3 through a range of 320-340 degrees before encountering surface 72d.

Expansion forces can be provided by the rotary fluid seal, such as the seal 64a′. Additional elastomeric material could also be provided as would be understood by those of skill in the art.

FIGS. 5A,B illustrate a rotary connection which incorporates an exterior locking sleeve 76. Sleeve 76 is cylindrical with first and second pluralities of locking fingers, such as 76-1, 76-2 carried at opposite ends of body 76a. The fingers 76-1,-2 slidably engage grooves or slots 76-3,-4, best seen in FIG. 5B. to implement a rotary connection.

As illustrated in FIG. 5B, when the sections 32a-4,b-4 abut or are adjacent to one another, sleeve 76 can be slid onto the end regions engaging grooves 76-3,-4. The fingers, such as 76-1 are deflectable to a position 78b until end region 76b passes the edge of groove 76-3. In this state, the finger 76-1 returns to its undeflected state, moving in direction 78c such that the end 76b slidably enters respective groove 76-3 thereby rotatably locking the two sections together.

FIG. 6 illustrates details of one form of rotary electrical connection 80. Connection 80 includes a cylindrical member 80a which can be carried on either section, such as 32a,b; 32a-1,b-1 or the like. The member 80a carries a plurality of annular conductors, such as 80b,c,d.

The number of conductors 80b,c,d is not a limitation of the present invention. Those of skill will understand that the number of conductors 80,b,c,d corresponds to the number of conductors needed to couple electrical energy between the cable section 20 and the handpiece 12a.

The other housing section carries a plurality of brushes or sliding contacts, such as 82a,b,c. The brushes 82a,b,c are spring biased so as to slidably engage the conducting rings 80b,c,d. As the two housing sections rotate, such as 71c, d, the brushes 82a,b,c slide on the conducting rings 80,b,c,d thereby implementing a multi-conductor rotary electrical connection. The brushes 82a,b,c can be offset around the circumference of the conducting rings 80b,c,d.

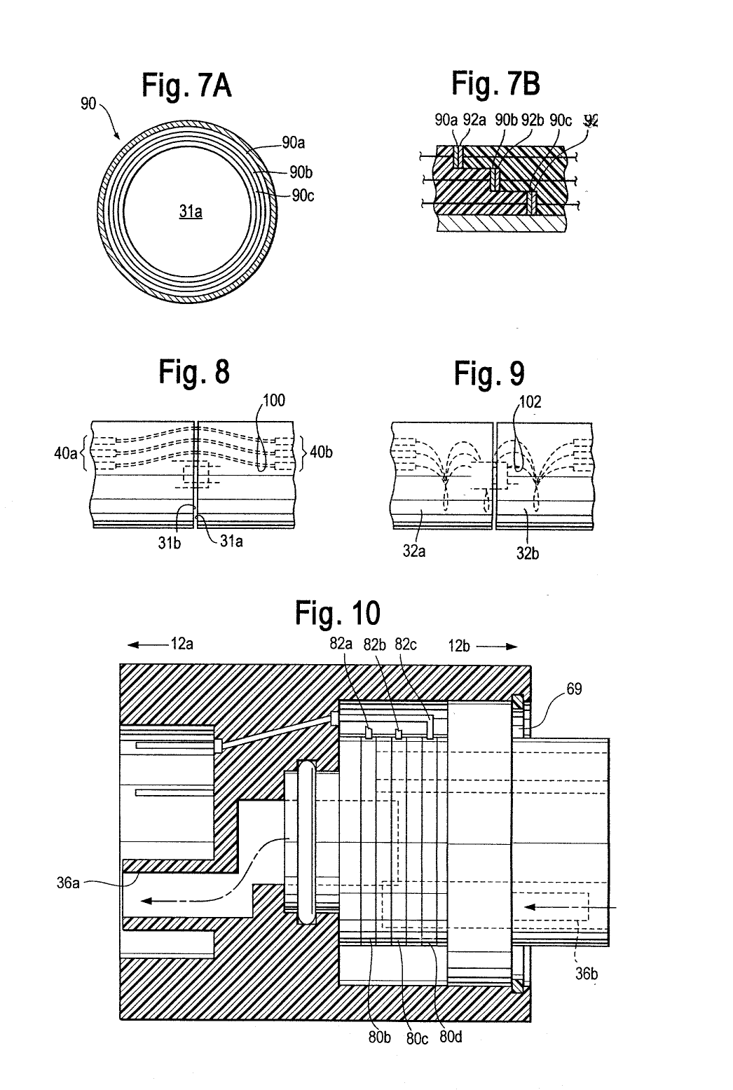

FIGS. 7A,B illustrate another form of rotary electrical connection 90. The connection 90 is implemented in part on each of the end surfaces, such as 31a,b. For example, and without limitation, surface 31a can carry a plurality of annular, concentric conducting rings 90a,b,c. These rings surround the centrally located flowpath 38a and share a common centerline.

The surface 31b can carry a plurality of spaced apart brushes or sliding conductors 92a,b,c. When the two sections 32a,b are rotatably locked together, the sliding contacts 92a,b,c bear against and slide on the concentric circles 90a,b,c thereby imnplementing another form of a rotary electrical connection.

FIG. 8 illustrates another form of rotary electrical connection. In the adapter of FIG. 8, discrete electrical wires 100 are connected between the connectors 40a,b. The wires 100 are long enough that the two housing sections can rotate almost an entire rotation, such as 320-340 degrees. Thus, the rotatability of the wires 100, which cross the two surfaces 31a,b outside of the rotary seal 34a, implements another form of a multiconductor rotary connection. Alternately, instead of discrete wires, a flexible cable can be used without departing from the spirit and scope of the present invention.

FIG. 9 illustrates yet another form of a rotary electrical connection. In the adapter of FIG. 9, a spring-like, coiled, multi-conductor element 102 extends between the two housing sections 32a,b. The element 102 electrically couples the connector element 40b to the connector element 40a.

As housing section 32a rotates relative to 32b, the coils of the spring member 102 expand and contract, depending on the relative directions of rotation while still coupling electrical energy between the connector elements. Hence, the structure 102 implements yet another form of a rotary electrical connection.

It will be understood that the invention is not limited to piezoelectric ultrasonic units. Other types of transducers can be used without departing from the spirit and scope of the invention.

It will also be understood that rotary couplings of the adapter 30 described above could be integrated into either the handpiece 12a or the connector 12b. In this instance, a separate adapter is unnecessary.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. An ultrasonic dental treatment device comprising:
a transducer carrying housing which has a proximal end and a tip receiving distal end;
a rotatable coupling element, carried on the proximal end, whereby the coupling element includes a sealed fluid flow conduit for providing treatment fluid to the housing and at least one electrical path for providing electrical energy to the housing whereby the housing can be rotated relative to at least a part of the coupling element while fluid and electrical energy are being provided to the housing.

2. A device as in claim 1 wherein the coupling element is removably connectable to the proximal end of the housing.

3. A device as in claim 2 wherein the coupling element includes at least a portion of a connector for connecting to the proximal end of the housing with one of a snap fit connection, a press fit connection, a twist lock connection and a threaded connection.

4. A device as in claim 1 wherein the coupling element includes first and second housings which are rotatably attached to one another and a fluid retaining seal therebetween.

5. An apparatus for an ultrasonic treatment device, wherein the apparatus can be positioned between a handpiece and a source element, the apparatus comprising:
a first and second rotatably coupled housing sections;
at least one electrical conductor extending between the sections and coupled thereto.

6. An apparatus as in claim 5 wherein one of the sections includes at least one laterally deflectable member and the other includes an internal recess wherein engagement of the member with the recess rotatably locks the sections together.

7. An apparatus as in claim 6 which incorporates an annular fluid seal trapped between the two sections.

8. An apparatus as in claim 6 wherein the at least one electrical conductor comprises a rotary electrical connection between the sections.

9. An apparatus as in claim 7 wherein the at least one electrical conductor comprises a rotary electrical connection between the sections.

10. An adapter insertable between a base and a handpiece of an ultrasonic instrument comprising:
a first portion which releasibly engages the base and incorporates a fluid flow input port along with at least one electrical connector configured to coupled a source of fluid and a source of electrical energy in the base whereby a fluid seal and an electrical connection are formed therebetween; and
a second portion which releasibly engages the handpiece and which includes a fluid flow output port and an electrical connector configured to couple to a dispensing fluid conduit and electrical conductor in the handpiece whereby a fluid seal and an electrical connection are formed therebetween wherein the handpiece and base are rotatable relative to one another.

11. An adapter as in claim 10 wherein the first portion engages the base with one of a push connection or a twist connection.

12. An adapter as in claim 11 wherein the first portion carries one of a surface for slidably engaging the base or a surface for rotatably engaging the base.

13. An adapter as in claim 10 wherein the second portion engages the handpiece with one of a push connection or a twist connection.

14. An adapter as in claim 13 wherein the second portion carries one of a surface for slidably engaging the base or a surface for rotatably engaging the base.

15. An adapter as in claim 10 wherein one portion carries at least one laterally movable member and the other carries a member receiving slot whereby the members are rotatably locked together.

16. An adapter as in claim 15 which includes a plurality of laterally movable members wherein the members are biased toward one another.

17. An adapter as in claim 15 wherein the slot comprises an annular recess.

18. An adapter as in claim 17 which includes a plurality of laterally movable members wherein the members are biased toward one another.

19. An adapter as in claim 17 wherein the laterally movable member has a surface which abuts a portion of the slot with a sliding interaction.

20. A method of operating an ultrasonic instrument with a handpiece comprising:
providing pressurized fluid and electrical energy;
coupling the fluid through a rotary interface to a proximal end of the handpiece; and
a coupling electrical energy, via an electrical rotary interface to the proximal end of the handpiece.

21. A method as in claim 20 which includes rotating the handpiece while coupling fluid therethrough from the rotary interface.

22. A method as in claim 21 which includes rotating the handpiece while coupling electrical energy through the interface.

23. A method as in claim 21 which includes coupling the rotary interface to the handpiece and providing a fluid resistant seal therebetween.

24. A method as in claim 23 which includes coupling electrical energy from the interface to the handpiece while rotating the handpiece.

25. An ultrasonic system with a handpiece having a proximal end and a distal end with a first connector element carried on the proximal end; a cable connector which carries a second connector element which non-rotatably mates with the first connector; comprising:
first and second housing portions rotatably coupled together and having a common centerline of rotation wherein each portion includes an internal conduit with at least one change of direction such that the conduits each have one end located on the centerline and a second end displaced therefrom such that rotation therebetween does not displace the one ends from one another.

26. The system as in claim 25 wherein the second ends respectively engage the first connector element and the second connector element whereupon the handpiece is rotatable with respect to the cable connector.

27. The system as in claim 26 wherein the housing portions each include electrical conductors which extend therethrough and which rotatably couple electrical energy therethrough as the handpiece is rotated relative to the cable connector.

28. The system as in claim 27 wherein the housing portions are rotatably coupled by one of a locking ring, a collet-like member and a twist lock-type connector.

29. A system as in claim 28 wherein the housing portions each carry a different electrical connector.

30. The system as in claim 29 wherein the electrical connectors are off-set from a centerline of the system.

31. The system as in claim 30 which includes an elastomeric seal between the housing portions.

32. The system as in claim 31 wherein the seal comprises a ring.

33. The system as in claim 27 wherein the conductors comprise at least one of a rotary electrical coupling and bendable conductive elements.

34. The system as in claim 32 wherein the conductors comprise at least one of a rotary electrical coupling and bendable conductive elements.

35. The system as in claim 33 wherein the rotary electrical coupling comprises one of a plurality of cylindrical, spaced apart conductors and a plurality of spaced apart annular conductors.

36. The system as in claim 34 wherein the rotary electrical coupling comprises one of a plurality of cylindrical, spaced apart conductors and a plurality of spaced apart annular conductors.

37. An adapter for an ultrasonic dental treatment instrument comprising:
a first housing located on a centerline and first and second ends wherein the first end carries part of an electrical connector and part of a fluid flow connector configured to releasibly mate with a respective connector part and flow connector on a source wherein the second end exhibits a fluid flow port symmetrical with the centerline;
a second housing which is located on the same centerline and has third and fourth ends wherein the third end carries part of another electrical connector and part of a fluid flow connector configured to releasibly mate with a respective connector part and flow connector on a treatment applying module wherein the fourth end exhibits a fluid flow port symmetrical with the centerline; and
whereby the locked housings rotate about the centerline.

38. An adapter as in claim 37 wherein each housing includes an internal, nonlinear flow path that deviates from a port on the centerline to a port off of the centerline.

39. An adapter as in claim 37 wherein each housing includes an internal, nonlinear conductive path which rotatably couples the two electrical connectors as the housings rotate relative to one another.

40. An adapter as in claim 39 wherein each housing includes an internal, nonlinear flow path that deviates from a port on the centerline to a port off of the centerline whereupon a sealed fluid flow path couples fluid between ends of the housings as they rotate.

41. An adapter as in claim 40 wherein the locking structures comprise one of a collet-type rotary connection, a split ring-type rotary connection a combination press fit-snap fit rotary connection, and a twist-lock rotary connection.

42. An adapter as in claim 40 which includes a fluid seal, symmetrical about the centerline.

43. An adapter as in claim 42 wherein the locking structures compress the seal.

44. An adapter as in claim 41 wherein the part of the electrical connector and the part of another electrical connector comprise one of a plug and a socket.

45. An adapter as in claim 41 wherein the part of the electrical connector comprises one of a plug and a socket.

46. An adapter as in claim 45 wherein the part of the another electrical connector comprises the other of the socket and the plug.

47. A system comprising:
an ultrasonic dental handpiece;
an electrical; fluid delivery cable coupled to the handpiece;
a mechanism, coupled to at least one of the handpiece and the cable, for rotating the handpiece relative to the cable.

48. A system as in claim 47 wherein the handpiece includes one of a piezoelectric transducer and a magnetostrictive transducer.

49. A system as in claim 47 wherein the mechanism is fixedly attached to one of the handpiece and the cable.

50. A system as in claim 47 wherein the mechanism is releasibly coupled to at least one of the handpiece and the cable.

51. A system as in claim 50 wherein the mechanism is releasibly coupled to both the handpiece and the cable.
